(19) United States
(12) Patent Application Publication
(10) Pub. No.: US 2026/0213653 A1
(43) Pub. Date: Jul. 23, 2026

(54) LEVEL-INCREASING SWITCHING ARRANGEMENT WITH A CHARGE PUMP

(71) Applicant: Neuroloop GmbH, Freiburg (DE)

(72) Inventors: Natalie Butz, Freiburg (DE); Armin Taschwer, Freiburg (DE); Max Eickenscheidt, Freiburg (DE); Oscar Cota, Freiburg (DE)

(21) Appl. No.: 19/157,738

(22) PCT Filed: Feb. 16, 2024
(86) PCT No.: PCT/EP2024/053979

§ 371 Date: Aug. 19, 2025

(30) Foreign Application Priority Data
Feb. 20, 2023 (DE) 10 2023 104 127.4

(51) Int. Cl. H02M 3/07; H02M 1/32

(52) U.S. Cl. CPC H02M 3/07; H02M 1/32

(57) ABSTRACT

A switching arrangement has a charge pump with a first contact connected to a first voltage potential, and a second contact connected via a circuit to a second voltage potential higher than the first voltage potential. The circuit has a first capacitor, a second capacitor and a first diode. The second contact is also connected to the first capacitor via a switching element. The charge pump has a third contact connected to an output of a first comparator having a first and a second comparator input. The first comparator input is connected to an anode potential of a second diode at which the second voltage potential is applied. The second diode is connected to the first diode and the second capacitor. The second comparator input is connected to a cathode potential of a third diode at the allocated anode of which the second voltage potential is applied.

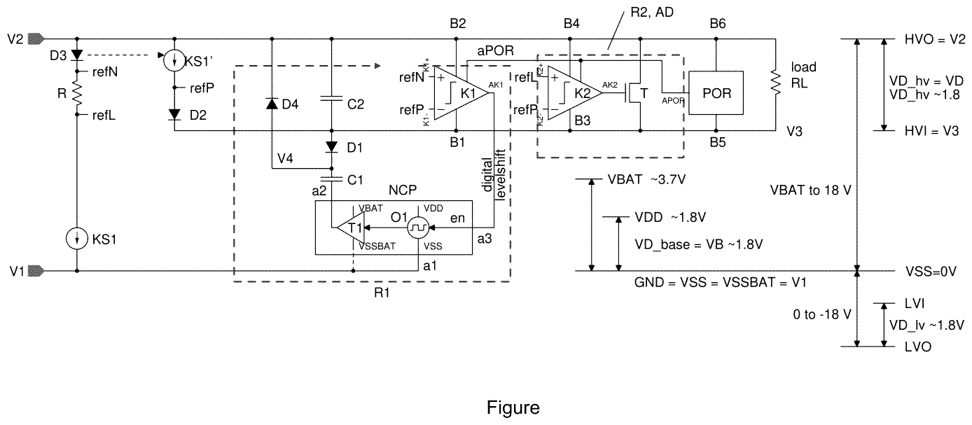

### CROSS-REFERENCE TO RELATED APPLICATIONS

This application is the United States national phase entry of International Application No. PCT/EP2024/053979, filed on Feb. 16, 2024, and claims priority to German Application No. 10 2023 104 127.4, filed on Feb. 20, 2023. The contents of International Application No. PCT/EP2024/053979 and German Application No. 10 2023 104 127.4 are incorporated by reference herein in their entireties.

### FIELD

The invention relates to an electric switching arrangement with a charge pump with which it is possible to generate, preferably electrical DC voltages in the form of operating voltages for the control or operation of various electrical components as required.

### BACKGROUND

Electrical switching arrangements, generically also known as voltage converters, are supplied with an input voltage, and with the help of electrical capacitors whose charging is coordinated by periodically switching over switches, variously high electrical output voltages can be produced. Depending on the circuit type, either higher output voltages with the same polarity or negative output voltages in comparison with the input voltage can be generated. For the periodic switching over of the switches, an oscillator is typically used.

In the book “On-chip High-Voltage Generator Design: Design Methodology for Charge Pumps”, Tanzawa, Springer 2015, a number of known switching arrangement with a charge pump are mentioned, including in particular the so-called “Dickson charge pump”, which is of especial interest hereinafter due to its simple control for integrated circuits.

A particularly preferred area of application that requires the use of charge pumps of the type in question, relates to implantable electronic devices for the treatment of various kinds of neurological function disorders through stimulation of the nerves with electrical charge. The electric switching arrangements forming the basis of these implants are multifunctional, highly integrated circuits which are designed on condition of maximum operational safety, maximum energy efficiency as well as the greatest possible miniaturisation.

### SUMMARY

The invention is based on the aim of further developing an electric switching arrangement with a charge pump in such a way that at least one property that forms the basis of the aforementioned conceptional objectives relating to operational safety, energy efficiency as well as miniaturisation is to be considerably improved compared to previous switching arrangements of the type in question.

The electric switching arrangement according to the solution, envisages a charge pump with at least two connection contacts, of which a first connection contact is connected to a first voltage potential and a second connection contact is connected, via a series circuit, which has at least one first capacitor, a second capacitor and first diode arranged between both capacitors, to a second voltage potential which is higher than the first voltage potential. The second voltage potential is connected to the first capacitor via a switching unit. In addition, the charge pump has a third connection contact which is connected to an output of a first comparator, which has two inputs, i.e. a first and a second comparator input. The first comparator input of the comparator is connected to an anode potential of a second diode at which the second voltage potential is applied, and which is also connected in series to the first diode and in parallel to the second capacitor. On the other hand, the second comparator input of the comparator is connected to a cathode potential of a third diode, at the allocated anode of which the second voltage potential is applied.

The switching solution according to the invention is based on an innovative arrangement concept, according to which the charge pump is arranged within the switching arrangement in a lower voltage domain that corresponds to a specified voltage potential, i.e. the input voltage. In contrast, all the electrical components that are responsible for controlling the charge pump are arranged in a higher voltage domain within the switching arrangement, i.e. the voltage domain that ensues by way of the voltage conversion be means of the charge pump.

Although hereinafter the terms lower and a higher voltage domain are used, with the switching arrangement according to the invention it is also possible, starting from a specific negative voltage domain, to create a numerically lower voltage domain through inverted voltage conversion. This case is also covered by the switching arrangement according to the invention.

In order to achieve an essential functional goal of the switching arrangement, a voltage difference of, for example, 1.8 V has to be transferred from a low voltage domain into a higher voltage domain, whereby it must be ensured that the voltage difference of 1.8 V converted or transformed into the higher voltage domain is retained, i.e. the voltage conversion by means of the charge pump must be controlled in such a way that the charge pump remans activated until the voltage difference of, for example, 1.8 V has been completely converted into a higher voltage domain. The voltage difference in the lower voltage domain thus relates, for example, to potential values of 0 V to 1.8 V and in the upper voltage domain, for example, 11 to 12.8 V. The reference points of the lower and higher voltage domain respectively can preferably differ up to 18 V and more, i.e. up to 60 V from each other, but they can also overlap. In the present example, the reference points are 0 V and 11 V.

The regulation or activation or deactivation of the charge pumps takes place in a controlled manner as part of a first control circuit that is essentially composed of the comparator and the second and third diodes, that primarily serve as reference point generators, all of which are arranged in the area of the switching arrangement's higher voltage domain that is formed by the successive charge accumulation in the second capacitor. On the other hand, the charge pump itself is arranged in the low voltage domain area.

The result of this is that current flow necessary for regulation is minimal between the lower and higher voltage domains, only a small current bias is required for regulation. With this, the individual switching areas—“ON”, i.e. the charge pump is activated, and “OFF”, i.e. the charge pump is deactivated—can operate with a minimal supply voltage and thus very power efficiently.

Preferably, the so-called first comparator determining the first control circuit, has two operating voltage contacts, of which one operating voltage contact is connected to the cathode allocated to the second diode, and the other operating voltage contact is connected to the second voltage potential.

If a power surge is detected by the first comparator, it generates a corresponding compactor signal that is transformed from the upper into the lower voltage domain and is applied on a connection contact of the charge pumps and deactivates it or switches if off, through which the power surge is reduced through its own consumption on the consumers connected to this voltage domain. Suitable for the purpose of transforming the comparator signal from the upper into the lower voltage domain, is a known level shifter or level converter which is connected between the first comparator and the charge pump or is part of the comparator and/or the charge pump.

If the charge pump erroneously or intentionally continues to pump or another event unintentionally increases the power surge, the voltage must be restricted.

Optionally, in order to further improve the operational safety of the switching arrangement, in addition to the first ON-OFF control loop, a further second control loop is provided in the upper voltage domain of the switching arrangement. If the power surge were to exceed a maximum value, a switch is activated through which the voltage difference is instantaneously reduced.

For this, the operating voltage contacts of a second comparator having a first and second comparator input, are connected in parallel to the operating voltage contacts of the first comparator. The first comparator input of the second comparator is connected to the anode potential of the second diode, like the first comparator input of the first comparator. The second comparator input of the second comparator is connected to a reference potential that forms between a load and the first supply potential, wherein the load is a constant load that is connected between the third diode and the first voltage potential.

The output of the second comparator controls the switch in the form of a transistor, the allocated source-drain section of which is connected in parallel to the operating voltage contacts of the first and second comparator. The second comparator and the transistor controlled by it, form an active diode, which autonomously acts as a safety element outside the first control circuit. The active diode is acted upon or operated with two bipolar reference voltages of two diodes respectively, which are both supplied with a constant current, through which the reliability of this safety measure brought about by the active diode is very high. Although in principle the provision of passive protection elements is an alternative protection option to the proposed active diode, they are very dependent on the current so that a set voltage limit can nevertheless be exceeded.

In the event that the specified voltage difference of, for example 1.8 V is exceeded and the first control circuit is not activated or, in spite of being activated, is unable to effectively reduce the forming power surge, the active diode switches, i.e. the transistor short circuits, as a result of which the accumulated electrical charge in the second capacitor can drain via the transistor and through this the power surge can dissipate.

All components and features, as well as their functions, that advantageously further develop the electric switching arrangement according to the invention, are explained below with reference to a specific switching topology.

### BRIEF DESCRIPTION OF THE DRAWING

The invention is described as an example below, without restriction of the general inventive idea, by way of an example of embodiment with reference to the drawing. In this:

The Figure shows the switching topology with indicated electrical potentials.

### DETAILED DESCRIPTION

The Figure shows a switching topology of an electric switching arrangement with a charge pump NCP, the operation of which, i.e. its activation and deactivation, is controlled by two control circuits redundantly coordinated with each other. Directly next to the shown switching topology, voltage or potential values are shown along a voltage axis. Thus, a first voltage potential V1 is at 0 V, which at the same time corresponds to the ground potential GND. The positive potential values marked upwards along the voltage axis reach a specified second voltage potential V2 of 18 V.

With the aid of the charge pump NCP, the goal is to convert or transform a voltage difference of 1.8 V from a lower voltage domain VD_base of, for example, 0 V to 1.8 V to a higher voltage domain VD_hv of, for example, 16.2 to 18 V. Solely for the sake of completeness, negative potential values, 0 V to −18 V, are also shown to make it clear that with an appropriately designed switching arrangement it is also possible to carry out voltage transformations in a negative voltage domain. The further description is restricted to voltage transformations in the positive potential range.

The charge pump NCP has two connection contacts a1, a2, of which a first connection contact a1 is connected to the first voltage potential V1=0 V and the second connection contact a2 is connected, via a series circuit comprising a first capacitor C1, a second capacitor C2 as well as a first diode D1 arranged between the two capacitors C1, C2, to a second voltage potential V2=18 V which is higher than the first voltage potential V1. In addition, for the purpose of controlled charge dissipation from the first capacitor C1, a current path with a switch, in the form of a diode D4 is provided in parallel to the second capacitor C2 and the first diode D2, between the first capacitor C1 and the higher voltage potential, comparable with a conventional Dickson charge pump.

The charge pump NCP has an oscillator O1 with an input and output as well as an electronic driver T1, wherein the input of the oscillator O1 is connected to a third connection contact a3 of the charge pump NCP and its output is connected to the driver T1. An output allocated to the driver T1 forms the second connection contact a2, which is directly connected to the first capacitor C1.

The third connection contact a3 of the charge pump NCP is connected to an output AK1 of a first comparator K1. As the first comparator K1 is arranged in the higher voltage domain and the charge pump NCP is arranged in the lower voltage domain, a level converter, i.e. a level shifter, is arranged between the connection contact a3 of the charge pump NCP and the output AK1 of the first comparator K1 and can optionally also be part of the comparator K1 and/or the charge pump NCP.

The first comparator K1 has two comparator inputs K1−, K1+, of which the first comparator input K1− is connected to an anode potential refP of a second diode D2, at which the second voltage potential V2 is applied and which is connected in series to the first diode D2 and in parallel to the second capacitor C2. The second comparator input K1+ of the first comparator K1 is connected to the cathode potential refN of a third diode D3, at the allocated anode of which the second voltage potential V2 is applied, and of which the cathode is connected via a constant load R to the first voltage potential V1. Between the constant load R and the first voltage potential V1, a constant current source KS1 is arranged. A further constant current source KS1′ mirrored with regard to the first constant current source KS1 is connected to the anode of the second diode D2, the cathode of which is connected to the anode allocated to the first diode D1. In addition, the first comparator K1 hase two operating voltage contacts B1, B2, of which a first operating voltage contact B1 is connected to the cathode of the second diode D2 and the second operating voltage contact B2 is connected to the second voltage potential V2.

Finally, the first comparator K1 is connected via a further control input to the output APOR or a reset switch (POR=power on reset), which in turn has two operating voltage contacts B5, B6 which are connected in parallel to the operating voltage contacts B1, B2 of the first comparator K1.

The first control circuit R1 controlling the charge pump NCP is thus composed of the first comparator K1, the charge pump NCO and the first and second capacitors C1, C2 connected therewith, wherein as control variables, the cathode potential refN of the third diode D3 and the anode potential refP of the second diode D3 form the basis of the control.

To realise a second control circuit R2 that additionally controls the activity of the charge pump NPC that becomes active in cases when the first control circuit R1 does not operate satisfactorily, a second comparator K2 is provided, the operating voltage contacts B3, B4 of which are connected in parallel to the operating voltage contacts B1, B2 of the first comparator K1. The second comparator K2 has two comparator inputs K2−, K2+, of which the first comparator input K2− is connected to the anode potential refP of the second diode D2 and the second comparator input K2+ is connected to a reference potential refL that builds up between the load R and the first constant current source KS1.

Via its output AK2, the second comparator K2 controls a transistor T, the source-drain section of which is connected in parallel to the operating voltage contacts B1, B2, B3, B4 of the first and second comparator K1, K2,

A load RL connected in parallel to the second capacitor C2 as well as to all operating voltage contacts B1, B2, B3, B4 of the first and second comparator K1, K2, represents a switching arrangement and constitutes a local consumer, which ensures instantaneous charge equalisation and an associated voltage reduction on the second capacitor, through which VD_hv decreases. The first comparator detects this voltage reduction and thereupon switches the oscillator O1 on in order to resupply electrical charge.

### Regarding the Operation of the Switching Arrangement

When the charge pump NCP is switched on, it is assumed that an upper voltage domain has not yet built up, i.e. VD_hv ~0 V.

As procedure, the switching on itself only involves an activation of a bias current through the current source KS1. Through this current, the reference voltages refN and refL are produced. The further reference voltage refP does not yet form, especially given that the voltage difference VD is still smaller than a diode voltage of around 0.8 V.

The first comparator K1 connected to the charge pump NCP is the only signal connection between the lower and upper voltage domains. So that a correct switching on procedure (start-up or ramp-up) can be successfully carried out, the first comparator is pre-configured by a global reset signal that is received by the first comparator K1 from the reset switch (POR=power on reset). The first comparator K1 allows the oscillator O1 in the charge pump NCP to start and is put in the ON state, i.e. via the driver T1 and the first capacitor C1, electrical charge is drawn from the second capacitor C2—it is “pumped”.

The charge pump NCP operates as a negative charge pump and is supplied from two different voltage domains. On the one hand, the base domain (VDD−VSS=1.8 V) that corresponds to the lower voltage domain VD_base, and on the other hand, from the battery voltage domain VBAT−VSSBAT=3 to 4.2 V. VSSBAT is always VSS and corresponds to the ground potential GND, The driver T1, that charges the first capacitor C1, is connected to the battery voltage domains VBAT/VSSBAT, i.e. a square wave signal between VSSBAT and VBAT is applied at the second connection contact a2 of the charge pump NCP. As the connection point of the fourth diode D4 to the first capacitor C1 and the diode D1 in equalized state is a high-resistance node, the potential V4 changes briefly there at the transitions with approximately the same amplitude as the potential on the connection contact a2 of the charge pump NCP. Only when the potential V4 reaches or exceeds the second voltage potential V2 plus a threshold voltage allocated to the fourth diode D4, does the fourth diode D4 open through which excess charge can flow from the first capacitor C1 to V2. Through this, in the following phase, a charge flow can be brought about that pumps charge from the second capacitor C2.

As a result of the dissipation of the charges., in the case of the recent potential shift in the capacitor C1, a charge imbalance occurs between the first capacitor C1 and the second capacitor C2 which is the driving force for the charge equalisation, through which charges from the second capacitor C2 reach the first capacitor C1 and, in addition, the voltage difference between V2 and C3 increases.

Through pumping charge from the second capacitor C2, the voltage difference CD increases over the second capacitor C2. During this “ramp-up” phase, the resect switch POR monitors the conditions in the first and the second comparator. Only on achieving a certain “ramp-up” speed (transients in V/s) and a voltage difference VD over around 1 V, does the reset switch POR transfer regular operation to the first and the second comparator K1, K2 for further control of the charge pump.

The voltage difference VD is already so high that the reference voltage refP also delivers a measurable specific voltage which now increases linearly with VD. If the reference voltage refP overlaps the reference voltage refN, the first comparator K1 becomes active and moves the charge pump NCP into the OFF state. In general, only a small bias current for the reference, sensor and comparators K1, K2 flows in the upper voltage domain VD_hv. Here refN and refL are the reference and refP is the sensor. In this way it can be achieved that if no consumers RL are active (e.g. RL is highly resistant), a change to ON operation (through inherent use) is delayed as long as possible.

The consumer RL connected in parallel to the second capacitor C2 is synonymous for a switching arrangement that is arranged between V2 and V3 and draws current from the second capacitor C2, through which the voltage difference VD reduces. As the reference voltage refP linearly follows the voltage difference VD, the point of intersection of the potentials refN and refP is reached and refP is below reference value refN so that the first comparator K1 changes the charge pump NCP back into the ON state.

The dynamics of the so-called “ramp-up” and “ramp-down” phase depend on various factors, for example on the capacitors C1 and C2 as well as on the frequency of the oscillator O1, according to which the transient on the second capacitor C2 forms with which temporal voltage changes take place.

If, through a too rapid transient and/or through constant ON operation, the voltage difference VD leaves the usual operating range and the first comparator K1 is nevertheless unable to prevent this, individual components could be destroyed. In this case, the active diode AD, i.e. the second comparator K2, in combination with the transistor T, acts as a protective mechanism which breaks the current VD through switching the transistor T via the second capacitor C2. In this case the transistor T opens and causes a short circuit, through which the charge flows off via the transistor. Switching of the transistor takes place until the hysteresis of the second comparator K2 is fallen below again.

### LIST OF REFERENCE NUMBERS

R1 First control circuit
R2 Second control circuit
NCP Charge pump
C1 First capacitor
C2 Second capacitor
D1, D2, D3, D4 First, second, third, fourth diode
refN, refP. refL Reference voltage
B1. B2, B3, B4, B5, B6 Operating voltage contacts
K1, K2 First, second comparator
a1, a2, a3 Connection contacts
K1−, K1+; K2−, K2+ Comparator inputs
AK1, AK2 Comparator outputs
KS1, KS1′ Constant current sources
POR Reset switch
APOR Output reset switch
AD Active diode
R, RL Loads
V1, V2, V3, V4 First, second, third, fourth voltage potential
O1 Oscillator
T1 Driver
T Transistor

1.-11. (canceled)

12. An electric switching arrangement with a charge pump which has at last two connection contacts, of which a first connection contact is connected to a first voltage potential and a second connection contact is connected via a series circuit, which has at least one first capacitor, a second capacitor and a first diode arranged between the at least one first capacitor and the second capacitor, to a second voltage potential which is higher than the first voltage potential and which is also connected, via a switching element, to the at least one first capacitor, wherein the charge pump has a third connection contact, which is connected to an output of a first comparator, which has a first and second comparator input, of which a first comparator input is connected to an anode potential of a second diode at which the second voltage potential is applied and which is connected in series to the first diode and parallel to the second capacitor, and of which a second comparator input is connected to a cathode potential of a third diode at an allocated anode of which the second voltage potential is applied.

13. The electric switching arrangement according to claim 12, wherein a cathode of the third diode is connected via a constant load to the first voltage potential.

14. The electric switching arrangement according to claim 13, wherein a first constant current source is arranged between the constant load and the first voltage potential.

15. The electric switching arrangement according to claim 12, wherein an anode allocated to the second diode is connected, via a constant current source, to the second voltage potential and its anode is connected to an anode allocated to the first diode.

16. The electric switching arrangement according to claim 12, wherein the charge pump has an oscillator with an input and output, as well as a driver, wherein the input of the oscillator is connected to the third connection contact and the output of which is connected with the driver, and wherein the output allocated to the driver corresponds to the second connection contact of the charge pump.

17. The electric switching arrangement according to claim 12, wherein the first comparator has two operating voltage contacts, of which one operating voltage contact is connected to a cathode allocated to the second diode and another operating voltage contact is connected to the second voltage potential.

18. The electric switching arrangement according to claim 17, wherein the two operating voltage contacts of the first comparator are connected in parallel to the two operating voltage contacts of a second comparator which has a first and a second comparator input, of which the first comparator input is connected to the anode potential of the second diode, at which the second voltage potential is applied, and of which the second comparator input is connected to a reference potential that builds up between a load and a first supply potential, and wherein an output allocated to the second comparator controls a transistor, a source-drain section of which is connected in parallel to the two operating voltage contacts of the first comparator and the second comparator.

19. The electric switching arrangement according to claim 17, wherein the first comparator is connected to an output of a reset switch which has two operating voltage contacts that are connected in parallel to the two operating voltage contacts of the first comparator.

20. The electric switching arrangement according to claim 12, wherein a second constant current course is arranged between the second voltage potential and the second diode.

21. The electric switching arrangement according to claim 12, wherein the switching element is connected in parallel to the first diode and the second capacitor between the second voltage potential and the at least one first capacitor.

22. The electric switching arrangement according to claim 12, wherein the switching element is designed as a fourth diode which for discharging the at least one first capacitor is connected in a direction of flow to the second voltage potential.
